(19) United States
(12) Patent Application Publication
(10) Pub. No.: US 2008/0085343 A1
(43) Pub. Date: Apr. 10, 2008

(54) Novel Low Allergenic Food Bar

(76) Inventors: Holly Tasha Petty, Carlsbad, CA (US); Sean Conrad McCoy, Gainesville, FL (US); Hordur G. Kristinsson, Gainesville, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/855,508

(22) Filed: Sep. 14, 2007

Related U.S. Application Data
(60) Provisional application No. 60/844,431, filed on Sep. 14, 2006.

(51) Int. Cl. A23J 1/00; A21D 10/00; A23L 1/30; A23L 1/303; B65D 85/00

(52) U.S. Cl. 426/73; 426/106; 426/656; 426/72; 426/74

(57) ABSTRACT

The subject invention provides novel low allergenic nutrient compositions. Advantageously, the low allergenic food products of the subject invention can be used as a replacement for a snack or meal in cases of hunger or fatigue for individuals diagnosed with a food allergy or degenerative or autoimmune disease, or for use as an ergogenic aid for persons participating in sports or other forms of exercise.

### CROSS-REFERENCE TO A RELATED APPLICATION

This application claims the benefit of U.S. provisional application Ser. No. 60/844,431, filed on Sep. 14, 2006, which is hereby incorporated by reference in its entirety, including all figures and tables.

### BACKGROUND OF THE INVENTION

Allergies are adverse immune reactions and are caused by the entry of foreign substances (allergens) into the body. A food allergy is an immune response to a food or a substance, normally a protein or glycoprotein, in a food naturally, or by contamination or produced by processing, cooking or digestion.

Currently, 12 million people (about 1 in 25) in the U.S. have food allergies. These individuals are affected by physical contact and/or consumption of the alleged food allergen. Undoubtedly, many individuals remain undiagnosed and are unaware that they have food allergies/intolerances. Food allergies are often confused with food intolerances; however, only food allergies illicit an IgE-antibody mediated response, producing multiple symptoms (National Institute of Food Allergy and Infectious Disease, “Food Allergy: An overview,” National Institutes of Health Publication No. 04-518 (July 2004)).

In addition to allergies, one in three people suffer from food intolerance and choose to refrain from eating certain foods (e.g., lactose intolerance). Food intolerances are adverse reactions that do not illicit an immune response; however, they may cause gastrointestinal symptoms. For example, celiac disease (celiac sprue) is a cell mediated inflammatory disease. An immune response to gluten causes damage to the small intestine, thereby causing nutrient malabsorption. Whether celiac disease is a food intolerance or food allergy is controversial. Gluten is commonly found in cereal grains including wheat, barley, and rye. Gluten-free adherence is imperative to living a happy life with this incurable disease.

The following allergens, also known as the “Big 8,” account for 90% of food allergies and severe allergic reactions: cow's milk, eggs, shellfish, soy, fish, peanuts, tree-nuts and wheat (Simpson, H. A., “Food Allergy,” JAMA 278:18888-1894 (1997); Bousquet et al., “Scientific criteria and the selection of allergenic foods for product labeling,” Allergy, 53S:3-21 (1998); Hefle et al., “Allergenic foods,” Crit Rev Food Sci Nutr, 36:S69-S89 (1996)). These foods contain various allergenic proteins (Gendel, “Sequence databases for assessing the potential allergenicity of proteins used in transgenic foods,” Adv Food Nutr Res, 42:63-92 (1998)). In recent years, food allergies to various ingredients such as dairy milk, eggs, shellfish, soy, fish, peanuts, tree-nuts, and wheat have been increasing.

Americans are detrimentally affected each year from consumption of processed food containing a diverse range of ingredients and additives. Various symptoms are associated with food allergies, varying in severity and possibly causing death. Multiple symptoms can manifest and include gastrointestinal, skin, and respiratory systems and can include the following: tingling in the mouth, swelling of the tongue, and/or throat, breathing hindrance, hives, vomiting, abdominal cramps, diarrhea, lowering of blood pressure, loss of consciousness, and death (Institute of Food Science and Technology (IFST), “Current Hot Topic: Food Allergens,” (2005)). Food allergies result in approximately 30,000 emergency room cases, 2,000 hospitalizations, and 150 deaths per year (Sampson, H. A., “Update on Food Allergy,” J Allergy Clin Immunol, 113(5):805-19 (2004)). Accordingly, it is critical that people recognize and avoid these allergies to avoid life threatening and troublesome symptoms.

Currently, no medical cures exist; strict avoidance of the offending allergen(s) is essential. Since many of these ingredients are inexpensive and contain abundant proteins, they are provided in many food products that are consumed in significant amounts. Removing such ingredients from everyday meals poses serious nutritious and economical problems to families of which members are suffering from a food allergy. In particular, removal of milks, eggs, wheat, and soybeans from meals of an athlete presents a serious problem from the aspect of dietetics and performance. Therefore, a desirable method would be to have them ingest foods from which the allergy causing components had been removed but where other nutritional components had not been impaired.

Conventionally, goat milks, milks from animal meat, soybean milks, and the like have been supplied to allergy patients as allergen-free foods. However, they have drawbacks. Goat milks are reported to be undesirable as a substitute for cow's milk to be administered to allergy patients, particularly to infant patients, because of the cross-reactivity between goat milk proteins and cow milk proteins (Food Intolerance in Infancy Allergology, Immunology, and Gastroenterology, edited by Robert N. Hamburger, Vol. 1, 253-265, Raven Press (1989)).

Soybean milks have been recommended as a good substitute of cow milk in many countries in America and Europe. In Asian countries, including Japan, however, many food allergy patients are allergic to soybean because of customary feeding of soybean in these areas. Furthermore, because of the high allergenicity of soybean, food allergy patients who are not allergic to soybean have been reported to become allergic to soybean (Heppell, L M et al., “A comparison of the antigenicity of soya-bean-based infant formulas,” Br J Nutr, 58(3):393-403 (1987)).

The popularity of nutrition bars has grown rapidly in recent years. Nutrition bars are convenient vehicles for replacement of a meal and for snacks intended to boost energy, increase or maintain athletic performance. Particularly as meal replacements, nutrition bars may be used by those seeking to lose weight.

In order to help meet nutritional necessities, nutritional bars were introduced which provided a portion of the minerals and vitamins, and incorporated proteins and carbohydrates to yield energy when consumed. However, many of these nutritional bars contain compounds recognized to be of high allergenicity, such as wheat, dairy milk, peanuts, and the like.

U.S. Pat. No. 3,434,843 discloses a food product which contains a homogeneous distribution of caloric and proteinaceous requirements. The food piece contains a continuous external phase of hydrophilic film former, water, and edible humectant, wherein the hydrophilic film former is selected from an egg product, dairy milk product, or soybean product.

U.S. Pat. No. 3,185,574 discloses a high protein wafer-like baked piece containing sufficient carbohydrate, protein, and fat to provide a balanced diet. The protein of the wafer comprises wheat gluten.

U.S. Pat. No. 3,901,799 discloses a high protein chocolate snack containing 30 to 50% by weight chocolate obtained by adding caseinates and peanut butter to a mixture of milk chocolate, dark chocolate, and cocoa butter.

U.S. Pat. No. 4,832,971 discloses a high protein, low-lactose nutritional bar that comprises protein derived from peanuts, soy, or wheat.

U.S. Pat. No. 6,346,284 discloses a nutritional supplement which contains a mixture of products, including those derived from dairy milk and wheat. The supplement can further contain a coating that contains peanuts or other tree-nuts.

U.S. Pat. No. 7,022,356 descries snack foods that comprise a nougat, where the nougat contains protein from sources such as peanut butter or nuts.

Unfortunately, as evidenced above, although conventional food/energy bars are unquestionably convenient, versatile, and great tasting, traditional food/energy bars are not particularly healthful for individuals who suffer from allergic reactions to common food products.

Food substituents to be supplied to food allergy/intolerant individuals, including typically milk allergy patients, must be free from allergenicity or must possess sufficiently low allergenicity, must have good taste and flavor, must be highly nutritious with excellent digestibility and absorptivity, and must be adaptable to long term intake by patients. These requirements, however, are contradictory to each other according to the current technological level. Neither nutrient compositions nor low allergenic formulas satisfying all above requirements have been developed heretofore. The absence of such nutrient compositions is a serious problem in view of the recent tendency of increasing numbers of food allergy patients. Development of a novel low allergenic nutrient composition, such as a food bar, has therefore been strongly desired.

Accordingly, there is a significant need for a new improved low allergenic food bar that is high in protein, low in fat, has great taste and texture, and can be readily produced, stored and used. The current invention addresses these and other related needs.

### BRIEF SUMMARY OF THE INVENTION

The subject invention provides novel low allergenic food bars. In particular, low allergenic food bars are provided that comprise a high protein content and substantially exclude compounds derived from the “Big 8” allergens, those being: dairy products, eggs, shellfish, soy, fish, peanuts, tree-nuts, and wheat. In a specific embodiment, the subject invention provides low allergenic food bars that comprise: at least one B-vitamin, Vitamin C, at least one fat soluble antioxidant, a short term energy substrate, leucine, a protein source, and at least one carbohydrate source, wherein the bar does not contain any of the Big 8 allergens (i.e., cow's milk, eggs, shellfish, soy, fish, peanuts, tree-nuts and wheat).

In one embodiment, a low allergenic food bar of the invention comprises an effective amount of one B vitamin, Vitamin C, vitamin E, creatine, leucine, a carbohydrate, and a fat source. In a related embodiment, the food bars of the invention have a low sodium content and require little or no insulin to be metabolized. Moreover, they do not cause sudden increases in blood sugar level. Preferred food bars of the invention are formulated to include low glycemic sources of carbohydrates that improve glucose control to help sustain energy levels.

According to the invention, the low allergenic food bar comprises an effective amount of dietary supplements so as to decrease fatigue, decrease mental fatigue, improve mood, conserve anti-oxidants in the sera, lower oxidative stress (lipid peroxidation), increase skeletal muscle protein synthesis (increases satellite cells) in an individual who has consumed the food bar.

Advantageously, the subject invention provides innovative products for individuals suffering from food allergies, in particular health conscience and/or athletic consumers desiring a quick and easy protein-rich, low-allergenic alternative to full-course allergenic foods. As people age, immune systems and metabolisms change, making it difficult for such individuals to consume foods containing the Big 8 allergens. The food bars of the subject invention are a healthy replacement for the typical food bars on the market today that normally contain one or more Big 8 allergens while lacking in ingredients that promote health and improved activity.

### BRIEF DESCRIPTION OF THE FIGURES

FIG. 1 is an illustration of a cross-section of a low allergenic food product provided in accordance with the subject invention.

FIG. 2 is an illustration of one embodiments of the invention.

FIG. 3 is an illustration of another embodiments of the invention.

FIG. 4 is an illustration of another embodiments of the invention.

FIG. 5 is an illustration of another embodiments of the invention.

FIG. 6 is an illustration of another embodiments of the invention.

FIG. 7 is an illustration of another embodiments of the invention.

### DETAILED DESCRIPTION OF THE INVENTION

The subject invention provides unique low-allergenic food bars, and advantageous methods for making and using these food bars. The invention pertains to novel low allergenic food bars that substantially exclude any compounds derived from any of the Big 8 allergens (dairy products, eggs, shellfish, soy, fish, peanuts, tree-nuts, and wheat). Specifically exemplified herein are food bars comprising at least one or more of any of the following ingredients: at least one B-vitamin, Vitamin C, at least one fat soluble antioxidant, a short term energy substrate, leucine, choline, creatine, alpha lipoic acid, a protein source, and at least one carbohydrate source, wherein the bars do not contain any substantial amounts of the Big 8 allergens. These food bars are advantageous because of the absence of Big 8 allergens, their high protein content, their great taste and pleasing texture, their storage characteristics, and their versatility of use.

It is contemplated herein that the subject low-allergenic food bars will improve the diet and health of individuals who suffer from allergies, autoimmune diseases, or age-related disorders. Accordingly, one embodiment of the invention is directed to novel methods for improving the health of individuals diagnosed with food allergies, autoimmune diseases, or age-related disorders. In particular, a combination of an effective amount of at least one B-vitamin, Vitamin C, Vitamin E, creatine, leucine, at least one protein source, and at least one high-fiber carbohydrate, are provided in low-allergenic food bar that is available for consumption by such individuals. Such ingredients aid in the digestive process to relieve constipation generally associated with some commonly prescribed medications as well as aid in energy metabolism, fatigue reduction, and mood enhancement.

Examples of allergies, autoimmune diseases, and age-related disorders that are addressed with the materials and methods of the invention include, but are not limited to, food allergies associated with the Big 8 allergens (i.e., cow's milk, eggs, shellfish, soy, fish, peanuts, tree-nuts and wheat); a diet lacking specific inclusion of nutraceuticals, nutrients, and conditionally essential nutrients and vitamins; food intolerance; celiac disease; multiple sclerosis; lupus; chronic fatigue syndrome; high cholesterol; diabetes; rheumatoid arthritis; cardiovascular disease; metabolic syndrome; sarcopenia; and the like.

In a related embodiment, the food bars described herein are provided to athletic individuals diagnosed with food allergies/intolerance who wish to improve overall energy levels and exercise performance.

In a preferred embodiment, the food bar comprises creatine, such as creatine monohydrate or creatine phosphate. More preferably, the food bar of the invention comprises about 0.01 to 5.00 grams of creatine monohydrate; about 750 mg of an anti-oxidant (such as Vitamin E); about 0.01-6.00 g of leucine; and at least one or any combination of more than one of the following B vitamins: B₁ (thiamine mononitrate) at about 1 to 20 mg; B₂ (riboflavin) at about 1 to 20 mg; B₃ (niacinamide) at about 0.01 mg to 10 g; B₅ at about 1 to 50 mg; B₆ at about 1 to 10 mg; Biotin at about 1 to 300 micrograms; Folic acid at about 1 to 400 micrograms; and B₁₂ at about 1 to 1000 micrograms.

Even more preferably, the food bar of the invention comprises about 0.01 to 5.00 grams of creatine monohydrate; about 0.01-300 mg of R-alpha lipoic acid; about 2 g of leucine; about 1 to 50 mg of choline; Vitamin C (ascorbic acid) 20-120 mg; and at least one or any combination of more than one of the following B vitamins: B₁ (thiamine mononitrate) at about 1 to 20 mg; B₂ (riboflavin) at about 1 to 20 mg; B₃ (niacinamide) at about 5 to 25 mg; B₅ at about 1 to 50 mg; B₆ at about 1 to 10 mg; Biotin at about 1 to 300 micrograms; Folic acid at about 1 to 400 micrograms; and B₁₂ at about 1 to 1000 micrograms.

In addition to ensuring low allergenicity, the present specification also describes a food bar with a high protein content. Some of the healthy functions performed by protein include supplying energy and building and repairing muscle tissue. Accordingly, the food bars of the invention comprise at least one protein source that is not derived from any of the Big 8 allergens. In certain embodiments, the food bars of the invention include vegetable-based proteins. Vegetable based proteins include any vegetable in which proteins may be collected, whether condensed, accumulated, or isolated. Examples of protein-providing vegetables include spelt, quinoa, amaranth, buckwheat, rice (such as black rice, wild rice, etc.), fava flour, garbanzo flour, and the like. Additionally, leucine, creatine, arginine, and L-proprionyl carnitine have the ability to be produced by microbial methods. Preferably, the food bar of the invention comprises at least 3 g of protein; more preferably, about 3 g, 4 g, 5 g, 6 g, 7 g, 8 g, 9 g, or 10 g of protein is present.

In certain embodiments, microbial ingredients are incorporated in the low-allergenic food bars of the invention. In one embodiment, acidophilis is incorporated into a food bar with high protein content. The microbial ingredients that are added to the food bars of the invention preferably assist in digestion and/or breakdown of the food bars endogenously.

The food bars of the invention can act as an ideal carrier for vitamins, minerals, and conditionally essential nutrients (CENs). Examples of vitamins that can be added to the food bars of the invention include, but are not limited to, vitamin A, vitamin K, para-aminobenzoic acid, niacin, inositol, and biotin. Examples of minerals that can be added include, but are not limited to, magnesium, iron, zinc, copper, manganese, sodium, potassium, calcium, selenium, chromium, molybdenum, chlorine, fluorine, phosphoris, sulfur, and iodine.

CENs are organic compounds normally produced by the body; however, in disease states these compounds become “conditionally” essential. CENS have been shown to be efficacious in improving cardiovascular disease (CV)-associated symptoms. Accordingly, the following CENs can be incorporated into a food bar of the invention in the following supplementation amounts: L-arginine (at about 6-21 g/day), proprionyl-L-carnitine (at about 0.50-5 g/day), coenzyme Q10 (at about 0.01-80 mg/day), and taurine (at about 0.5-3 g/day).

Food bars described herein can also contain botanicals or nutraceuticals including, but not limited to, bilberry, cascara, cat's claw, cayenne, cranberry, devil's claw, dong quai, echinacea, evening primrose oil, feverfew, garlic, ginger, ginkgo, Asian ginseng, Siberian ginseng, goldenseal, gotu kola, grape seed, green tea, hawthorn, kava, licorice, milk thistle, noni, saw palmetto, St. John's wort, valerian, melatonin, damiana, yerbe mate, guarana, red yeast rice, and the like.

The food bars of the invention may also comprise salts, seasonings, and flavorings (collectively “flavorings”) to make the food bar more desirable to the taste. The concentration of flavorings can be adjusted according to need and taste. Examples of flavorings include, but are not limited to, mint, peppermint, spearmint, cinnamon, nutmeg, cloves, ginger, wintergreen, vanilla, fruit, fruit extracts and essences, peppers, chili pepper, chocolate, carob, caramel, sarsaparilla, sassafras, salt, wild cherry, ginger, nutmeg, malt, grain flavors, paprika, garlic, sunflower, peanut butter and jelly, cookie dough, black cherry, cranberry, strawberry, apricot, chocolate cinnamon, prune, cinnamon raisin, apple cinnamon, carrot cake, pumpkin spice, and other flavorings well known to those of skill in the art. Chocolate flavoring is preferred because it masks certain unfavorable flavors (such as protein) as well as satisfying a large populous pallet.

The flavorings can be added in any proportion or combination to achieve the desired taste. For example, salt and vanilla can comprise any proportion of the total flavoring but generally each comprises less than about 2% of the food bar. In one aspect, concentrated fruit juices and purees along with dried fruit pieces are used in the food bar of the invention for flavoring and can comprise up to about 97% of the total flavoring.

In another aspect the food bar of the invention also contains water. Water performs the function of adding moisture to the mixture and helps the ingredients mix completely to form a homogeneous food product. Water activity (a_{w}) is an important aspect to shelf-life as well as processing of the subject food bar. According to the subject invention, the water activity of the subject food bar ranges from about 0.6 to about 0.95 a_{w}. In one embodiment, where the food bar includes a filling, the bar has a 0.70 to 0.75 a_{w}. In one aspect, the ratio of water to dry ingredients ranges from about 1:5 to about 1:1. Preferably, the ratio of water to dry ingredients ranges from about 1:3 to about 1:2. Contemplated wet ingredients for addition to the food bar of the invention include, but are not limited to, juice, water, oil, flavored extracts, and the like.

Water is generally absorbed by the dry ingredients, particularly the proteins. In another aspect, the ratio of water to protein material ranges from about 1:4 to about 1:14.

The present specification also describes food bars that can include dressings to add flavor, texture, and eye appeal. The dressings include, but are not limited to, caramel, chocolate, fruit, grains and cereals, or any combination thereof, and can be incorporated in the food bars in many different methods. Such dressings are preferably non-allergenic.

According to the subject invention, the food bars include creatine. Exercise makes excessive demands on substrates both within and external to muscle. Creatine phosphate is derived from both dietary creatine and from endogenous synthesis. Creatine phosphate is essential for short term energy supply during anaerobic conditions and also for energy transfer from mitochondria to contractile muscle. Muscle cannot function efficiently or at a high level of power output if reserves of creatine are low or sub-optimal. Depletion of creatine in athletes causes poor performance and poor efficiency. The low-allergenic food bars of the invention, which provide creatine, are thus useful as a supplement for improving athletic performance.

Use of fiber in the bar is advantageous because different fiber products influence the release of sugars, affect the binding of various components, advantageously delay digestion, and can be used to provide a desirable texture to the food bar. Forms of fiber products that can be included in the food bar of the invention include, but are not limited to, fiber from rice bran, fruit (such as apple, grapefruit, etc.), insulin (a fiber derived from chicory root), and vegetables (such as from peas, sugar beets, etc.).

In one embodiment of the invention, the subject low-allergenic food bar comprises at least about 10% of the Daily Recommended Value (DRV) for fiber. In a related embodiment, the food bar of the invention comprises about 10%-20% (or about 2.5 g to about 5 g of fiber) of the DRV for fiber. In certain embodiments, the food bar of the invention comprises greater than 20% (or greater than about 5 g of fiber) of the DRV for fiber. According to the U.S. Food and Drug Administration, the DRV for fiber is based on 11.5 g or fiber per 1,000 calories consumed per day.

In certain embodiments of the invention, various micronutrient combinations are provided in a food bar specific for different target age group populations. For example, for a food bar to be provided/marketed for children, the food bar can provide about 5% to 35% maximum of Reference Daily Intake (RDI) for typical vitamins/minerals (see Table 1 below as provided by the U.S. Food and Drug Administration). In another embodiment, a food bar to be provided/marketed for adults includes about 5% to 50% maximum RDI for typical vitamins/minerals. In yet another embodiment, a food bar to be provided/marketed for senior citizens includes materials that provide a softer texture for ease of mastication; further, the food bar can be fortified with vitamins D and C.

TABLE 1
Reference Daily Intakes (RDIs):

| Nutrient | Amount | |
|---|---|---|
| Vitamin A | 5,000 | International Units (IU) |
| Vitamin C | 60 | milligrams (mg) |
| Thiamin | 1.5 | mg |
| riboflavin | 1.7 | mg |
| Niacin | 20 | mg |
| Calcium | 1.0 | gram (g) |
| Iron | 18 | mg |
| Vitamin D | 400 | IU |
| Vitamin E | 30 | IU |
| Vitamin B6 | 2.0 | mg |
| folic acid | 0.4 | mg |
| Vitamin B12 | 6 | micrograms (mcg) |
| phosphorus | 1.0 | g |
| Iodine | 150 | mcg |
| magnesium | 400 | mg |
| Zinc | 15 | mg |
| Copper | 2 | mg |
| Biotin | 0.3 | mg |
| pantothenic acid | 10 | mg |

In another embodiment of the invention, various micronutrient combinations are provided in a food bar specific for target gender populations. Research has indicated that over a majority of 45 year old women (85%) prefer to fulfill a required serving of fruit via a convenient food bar. According to one embodiment, a food bar of the invention is provided that includes a full serving of fruit.

In certain embodiments, to ensure integrity and bioavailability of nutritional supplements provided in the subject food bar, the nutritional supplements are microencapsulated. For example, heat, pH, moisture, and oxygen all pose challenges in ensuring quality during storage and production of the food bar. To address these issues, the various nutritional supplements described herein (such as vitamins, minerals, fibers, and the like) are microencapsulated using well known techniques.

In one embodiment, nutritional supplements are blended with a powder to create a compressed powder. The blending may be performed by a standard mixing means, using a Vee Blender, a Ribbon Blender or other mixer. The powder is formulated to provide a compressible matrix, using bulk fillers, sorbitols, sugars, polyols, starches, sugars modified with starches and the like. Preferably, this filler can range from approximately 10 to about 95% by weight composition of the powder and nutritional supplements blend. Preferably nutritional supplements may range from approximately 0.001 to about 60% by weight of the powder and nutritional supplements blend. Other excipients can also be used in the powder that are useful in modifying mouthfeel and organoleptic properties of the nutritional supplements and/or food bar. Excipients may also be used to modify dissolution and disintegration properties and binding of the nutritional supplements. Preferably the weight of the powder and nutritional supplements blend may range from approximately 10 to about 90% weight of the total food bar weight.

As noted above, if desired, the nutritional supplements can be encapsulated or they can be provided in free form. In order to produce the encapsulated nutritional supplements, a variety of technologies can be utilized. For example, film coating technologies can be used to provide effective bioavailability of the nutritional supplements. A number of materials can be utilized to encapsulate the nutritional supplements including, natural polymers, synthetic polymers, modified cellulose, waxes, fats, oils, and proteins. In addition, a diverse range of modifiers can be used, including, but not limited to, plasticizers, pore formers, disintegrants, waxes, lipids, fats, fatty acids, polylactides, solubilizers, and absorption enhancers.

Several encapsulating techniques can be used to encapsulate the nutritional supplements. These include fluid-bed coating and its variations, low-shear wet granulations, high-shear wet granulations, and spray dry processes. The encapsulations provide for coated solid particles and matrix dispersions. This enhances bioavailability, taste masking, and tailored release profiles. It has been found that high-shear granulations of active powder with modifying agents provide for taste masking, absorption enhancement, dissolution aides, and mouth feel modifiers.

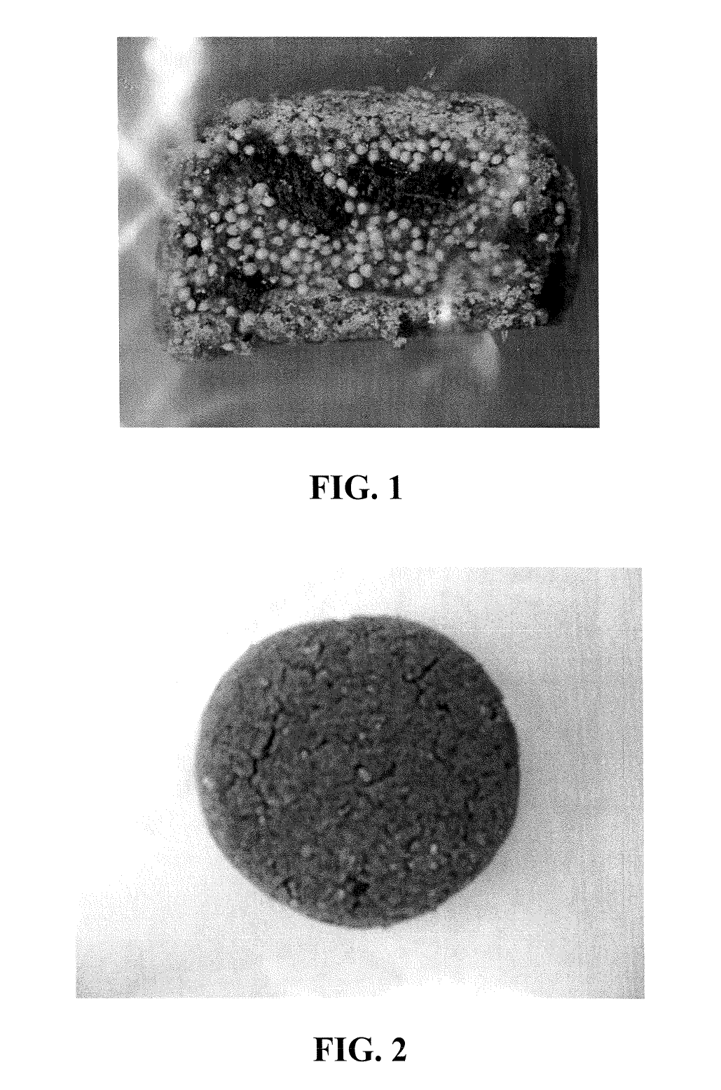

The low-allergenic food bars of the subject invention can be made in just about any shape (such as bars, cookie/circular shapes, snack bites, toppings, or the like). Specifically exemplified herein is the production of traditional rectangular shaped food bars (see FIG. 1). The size of the food bar can also be adjusted to suit a particular need. Thus, for a food bar, the dimensions may be, for example, from about 3×6 inches to 4×8 inches or more. The preferred thickness of the food bar can also be readily determined by a person skilled in the art. The thickness may be, for example, from about ½ inch to ¾ inch or more. The food bar may weigh, for example, about 100 g, with about ≧10 g of protein per bar.

In a preferred embodiment of the invention, the low-allergenic food bar comprises: carbohydrates, protein, vitamins and minerals, dietary blend of supplements, a gelling agent, a wetting agent, sweeteners, flavoring agents, leavening agents, and emulsifying agents. The carbohydrate can be selected from any one or combination of the following ingredients: pea, buckwheat, tapioca, rice, quinoa, millet, amaranth, sorghum flour, fava flour, and garbanzo flour. Amounts for preferred carbohydrate ingredients that can be provided in a food bar of the invention (that weighs a total of 100 g per bar) are as follows: buckwheat at about 0% to 70% by weight; tapioca at about 0.5% to 70% by weight; quinoa at about 0.5% to 70% by weight; rice at about 0.5% to 70% by weight; millet at about 0.5% to 70% by weight; and amaranth at about 0.5% to 70% by weight.

The protein preferably is one derived from grains. The dietary blend of supplements provided in the food bar can be selected from any one or combination of the following ingredients: creatine, choline, leucine, carnitine, arginine, and alpha lipoic acid. Amounts for preferred supplements that can be provided in a food bar of the invention are as follows: creatine at about 0.001% to 5% by weight; choline at about 0.001% to 1% by weight; leucine at about 0.001% to 3% by weight; and alpha lipoic acid at about 0.001% to 1% by weight.

The gelling agent included in a food bar of the invention can be any known gelling agent appropriate for food ingredient use (such as gelatin) and that is void of any of the Big 8 allergens. The amount of gelling agent provided in a food bar can range from about 0.001% to 5% by weight of the entire content of the food bar.

The wetting agent included in a food bar of the invention can be any known liquid appropriate for food ingredient use (such as water, juice, rice milk, hemp milk, etc.) and that is void of any of the Big 8 allergens. For example, the wetting agent can be derived from grains, legume, or seed source. The amount of wetting agent provided in a food bar can range from about 1% to 50% by weight of the entire content of the food bar.

The sweetener included in a food bar of the invention can be any known sweetener appropriate for food ingredient use and that is void of any of the Big 8 allergens. For example, the sweetener can be selected from a refined sweetener (such as glucose, etc.) or unrefined sweetener. The sweetener can be a non-nutrative, low-caloric, non-caloric, or a blend of any sweeteners. Preferably, the sweeteners used in the food bars of the invention do not provide high amounts of calories and do not increase blood sugar levels and/or cause little or no insulin to be released. Examples of sweeteners that can be provided in a food bar of the invention include, but are not limited to, sugar alcohols (such as mannitol, sorbitol, xylitol, lactitol, isomalt, maltitol, and hydrogenated starch hydrolysates (HSH)) and high intensity sweeteners (such as aspartame, alitame, cyclamates, saccharin, acesulfame, sucralose, neohesperidin dihydrochalcone, stevia sweeteners, glycyrrhizin, thaumatin, and the like). The amount of sweetener provided in a food bar can range from about 1% to 80% by weight of the entire content of the food bar.

Because many sugar substitutes sweeteners, in particular high intensity sweeteners, do not have the same weight or bulk as refined sugars, a bulking agent may be necessary to provide the desired texture and consistency of the food bar. This can be achieved by adding inulin, oligofructose, or a sugar alcohol to the food bar.

Inulin and oligofructose mimic sugar's viscosity, texture, humectancy, freezing point depression and water binding activity. They have a mild sweetness and can also form a gel with fat-like characteristics that adds creaminess to the product. Using small amounts allows taste and texture of low carbohydrate, low fat products to be improved, thus making them useful as sugar and fat replacements for many food products. Inulin and oligofructose are also good sources of soluble dietary fiber and are well suited for diabetics because they do not increase the blood sugar level or insulin level due to its indigestible nature.

The flavoring agents included in a food bar of the invention can be any known liquid appropriate for food ingredient use (such as fruit, chocolate chips, raisins, masking agent for masking undesirable flavors, etc.) and that is void of any of the Big 8 allergens. The flavoring agent can be a non-nutrative, low-caloric, non-caloric, or a blend of any flavoring agents. The amount of flavoring agent provided in a food bar can range from about 0.001% to 50% of the entire content of the food bar.

Leavening and emulsifying agents included in a food bar of the invention are provided in a range from about 0.001% to 5% of the total content of the food bar for the leavening agent and about 0.001% to 15% of the total content of the food bar for the emulsifying agent. The emulsifying agent is preferably provided in liquid form and is non-hydrogenated.

A preferred food bar of the invention is low in sodium content and is formulated to include low glycemic sources of carbohydrates that can improve glucose control to help sustain energy levels. The food bar in particular includes fructose which has been shown to diminish food intake and reduce gastric emptying. The food bar also contains levels of fiber and protein which help lower the glycemic level, and fat at levels which help reduce gastric emptying and blunt any sharp rises in glucose levels.

Process Description

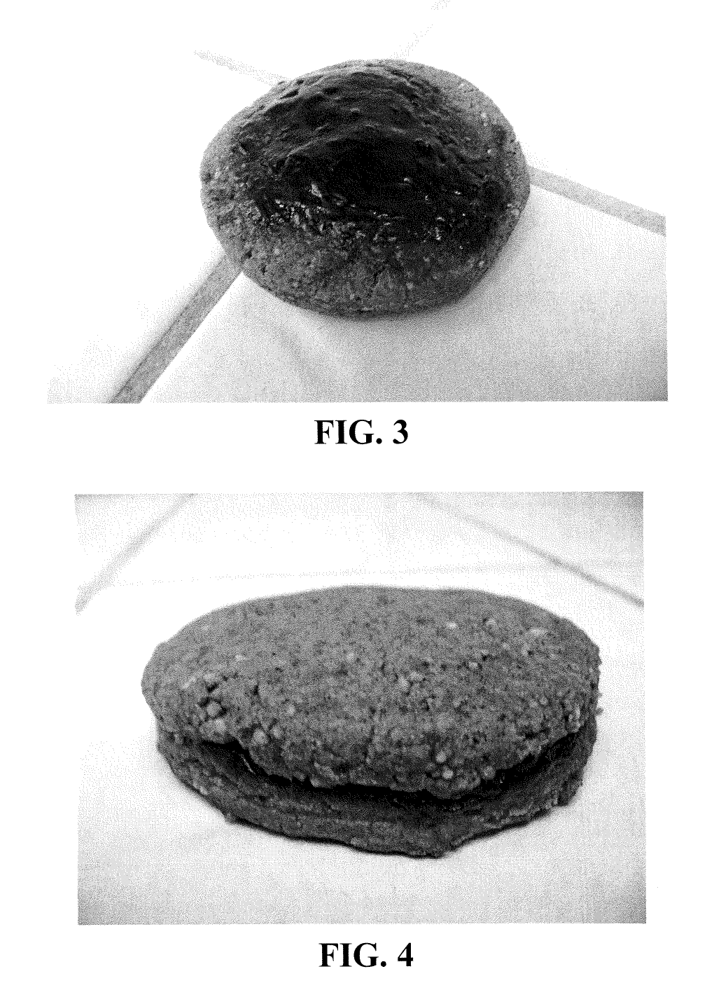

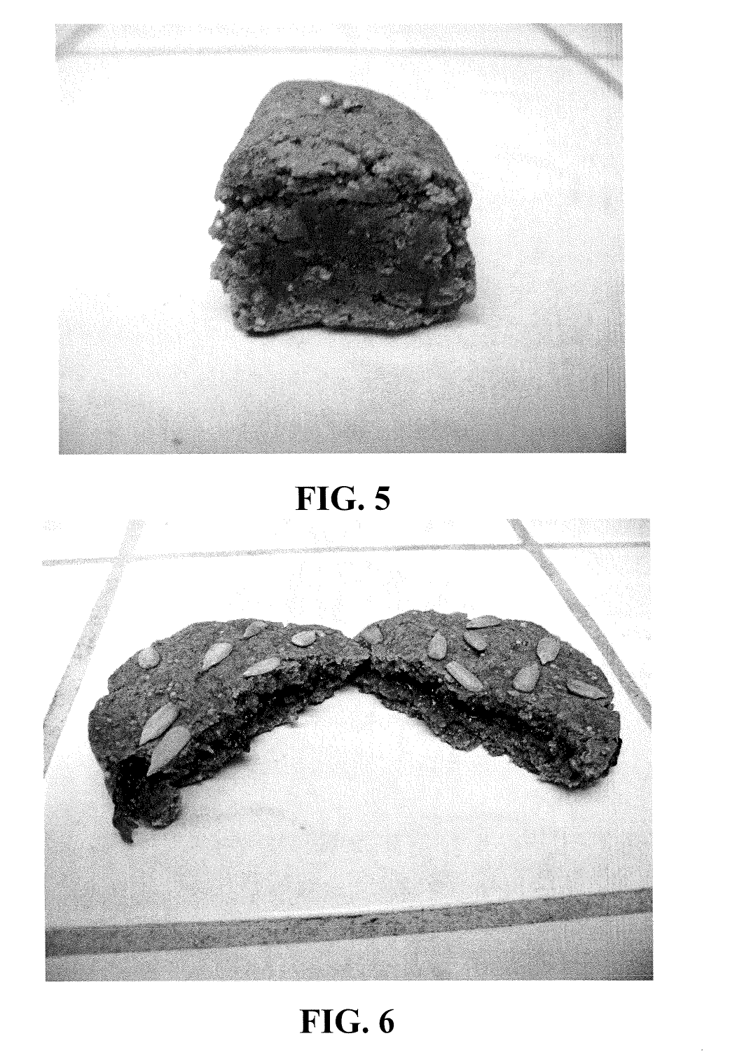

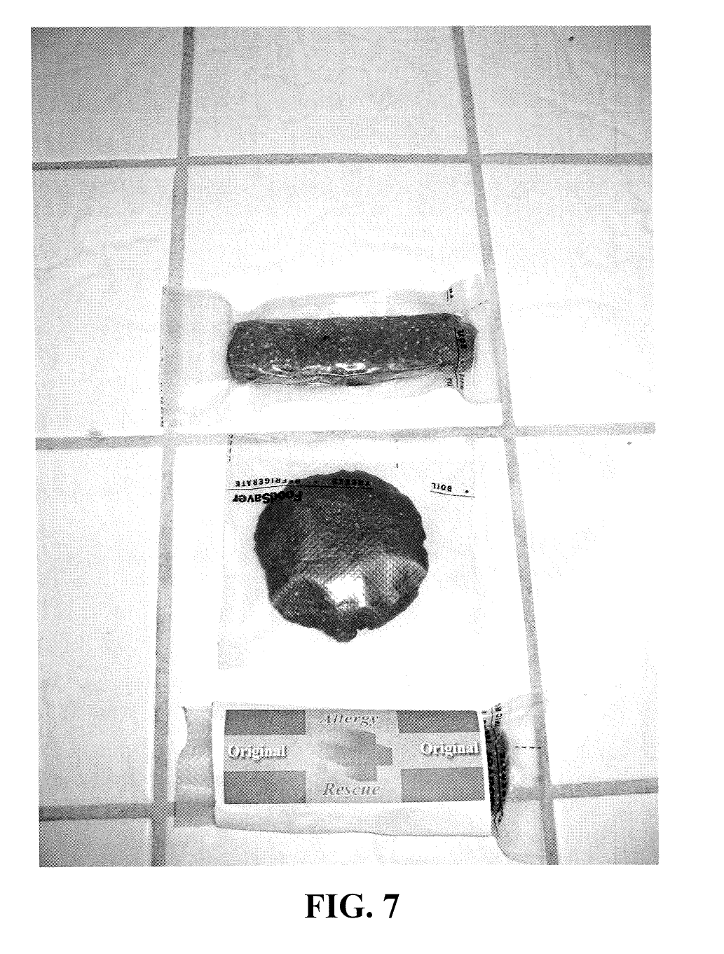

Food bar production can be accomplished based on manufacturer requirements. Various food bar products that can be prepared in accordance with the methods described herein are illustrated in FIGS. 2-7.

In one embodiment, the initial preparation of low-allergenic food bars prepared according to the subject invention can begin with processing dry ingredients (such as flours, baking powder, flavorings, sugars, and the like) with wet compounds (such as water, juice, flavoring extract, and the like) to provide a dough. Any known devices available for preparing doughs through the mixture of wet and dry ingredients (such as a mixer, etc.) can be used in this step.

In certain embodiments, the dough is cold pressed to form an edible bar. These uncooked bars may be treated against pathogenic microorganisms to secure a safe product for consumption. In other embodiments, the dough is baked or heated to provide a food bar of the invention.

Alternatively, a food bar of the invention can include a filling. The filling can include: a wetting component (such as water, fruit juice, water and fruit puree and/or preserves (i.e., fruit and pectin and/or gelatin and a sweetener); a thickener composed of a carbohydrate source substantially devoid of compounds from the Big 8 allergens (including those carbohydrates described herein); and a sweetener. In certain embodiments, the filling can further include supplements, flavoring components, and texture components (such as seeds). All of the ingredients of the filling are prepared using a blending device. The filling can be produced through the incorporation of the liquid with the solid ingredients, not limited to cooking, but simply mixing the filling ingredients. The liquid components are then lightly heated (for example, heating can range from 70° C. to 100° C. or greater). During the heating process, thickener (gelatin, sweetener, etc.) are added. The prepared filling is allowed to set in under cool conditions (such as at about 4° C.) until malleable. After malleable texture is attained, the filling is shaped into a log-like shape (for example, by machine or by hand and then was applied to the rolled out dough (which can be rectangular in shape or any other shape as described below). The dough is then folded over the filling.

In those food bars that contain whole amaranth and/or quinoa, the whole amaranth is mixed with liquid ingredients (such as flavorings, water, and sweetener) and browned. In certain embodiments, the whole amaranth and/or quinoa is hydrolyzed to increase bioavailability, shelf-life, and texture quality. The mixture is then heated at approximately 25° C. to 55° C. and constantly stirred until an appropriate degree of hydrolysis is reached. As understood by the skilled artisan, the process is dependable on processing conditions: extent (time), and conversion method (acid, oxidant, enzyme, heat, and/or combinations), see Thomas, D. J. and Atwell, William A. Starches, 1997. Eagen Press, St. Paul, Minn. During the heating process, as described above, thickener (such as gelatin, sweetener, etc.) is added.

The dough is rolled out into appropriate portions and to a thickness of a few centimeters.

In one embodiment, the dough is transferred via conveyor belts and hoppers, for example, to a conventional confectionery-type bar extruder, such as a Werner-Lahara bar extruder having opposing two- or four-rollers which force the mixture through a die to form the extrudate or core. The extrusion is performed at about room temperature. Where there is a filling, the filling is shaped into a log and place on the rolled dough/extrudate; the dough/extrudate is folded over the filling and sealed at the ends. The preferred extruded shape is a rectangular bar, but other shaped bars, known in the snack bar art, such as cylindrical, and semicylindrical shaped bars can be made using appropriate extruder dies.

The extrudate is cut into individual serving size pieces, by means of a guillotine-type cutter or a wire cutter, for example, in conventional manner. The cut pieces may then be coated, by enrobing, spraying or dipping for example, with a dressing material. The dressing material may be the same or different from the mixture from which the filling is made. The finished food bar product is then baked at about 375° C. for about 20 or less minutes or until the crust is somewhat hard.

The food bar is then packaged, preferably in a conventional foil laminate food grade packaging film. Packaging in a foil laminate film preserves the moisture content of the bar and prevents it from becoming dry and crumbly over an extended period of time. The interior of the package can be flushed with an inert gas, such as nitrogen, in conventional manner to reduce the oxygen content in the package.

The nutritional bars of the present invention are suitable as snacks for children and adults, hikers, skiers, mountain climbers, athletes, and the elderly who wish to be certain their nutritional needs are properly satisfied.

To ensure the food bar of the invention is substantially free of Big 8 allergens, any one or several of the following steps are taken before, during, or after the production of the bar: 1) schedule production of allergy products first; 2) wash equipment; 3) separate non-allergenic from allergenic ingredients; 4) allot bins for non allergenic and allergenic ingredients (i.e., different colors, different rooms, etc.); 5) control dust and dust contamination (such as by maintaining proper air flow, vent systems, and equipment to prevent dust contamination of allergens); 6) set up appropriate staging and batch preparation (i.e., mixing, ballot and lot numbers); 7) obtain adequate batch records; 8) line clearance (i.e., remove all ingredients from previous products before starting production of another product; 9) provide check off lists and clearance forms; 10) verification using test kits with detection limits as low as 1 ppm; 11) ensure appropriate product facility design to prevent cross-contamination of allergens (for example, manufacturing a food bar on a single line); 12) obtain ingredient mixes derived from pre-mix companies, which enables lower cost, consistency, inventory control, and better hazard control; and 13) packaging the finished food product in latex free and lead free containers/wrappers.

According to the subject invention, low-allergenic food products substantially exclude compounds derived from the Big 8 allergens. Preferably, “substantial” exclusion of Big 8 allergens relates to levels of Big 8 allergens that provide No Observed Effect level (NOAEL) or Lowest Observed Adverse Effect level (LOAEL) as defined by the U.S. Food and Drug Administration. More preferably, a food bar of the invention contains levels of Big 8 allergens that fall within or below the ranges described in Table 2 below. Proposed gluten-free thresholds for food bars of the invention include gluten provided at less than or equal to 20 ppm, gluten provided at less than or equal to 200 ppm.

TABLE 2
Ranges of Big 8 Allergens

| Food | Range of LOAEL (mg protein) |
|---|---|
| Egg | 0.13-1.0 |
| Peanut | 0.25 to 10 |
| Milk | 0.36 to 3.6 |
| Tree- nuts | 0.02 to 7.5 |
| Soy | 88 to 522 |
| Fish | 1-100 |

Nutritional Information

In comparing the various food bars available in the market to the low-allergenic food bars of the subject invention, the functionality of holding various fillings is similar. However, one primary difference separates the food bars of the current invention and that is the nutritional characteristics and low-allergen load. Food bars produced according to the subject invention lack the presence of Big 8 allergens and include ingredients that promote healthy living. Protein is normally used for biological building blocks and not as a primary source of energy. The low-allergen food bars of the subject invention have a higher proportion of protein (preferably >5 grams protein) compared to commercially available food bars that include one or more Big 8 allergens and normally include around about 2 grams of protein. The low allergen food bars of the invention can have about 1 g, 5 g, 10 g, 15 g, 20 g, 25 g, or 30 g, and up to about 35 g of protein. This allows the subject food bars to be an excellent food for building muscle mass or as a part of a high protein diet (i.e. Atkin's Diet).

Another major advantage of the low allergenic food bars is their use in specialized diets, such as individuals diagnosed with food allergies, degenerative/autoimmune disorders, or age-related disorders. For example, these food bars can be utilized as a gluten-free alternative for individuals with wheat allergies, wheat/gluten intolerances, and/or gluten-sensitive enteropathies. These are very serious disorders with severe or fatal outcomes if a strict diet is not followed.

In one embodiment, the food bars of the subject invention are available to individual consumers for home use via sales in retail stores such as grocery stores, gourmet food boutiques, and convenience stores. In a related embodiment, the food bars are available at specialized stores or establishments, such as spas, exercise gyms, physician's offices, and the like. In a similar embodiment the food bars are also available over the internet for distribution.

A few examples of food bar flavors that can be offered include: watermelon, chocolate, fudge, vanilla, any and all citrus related flavors (orange, tangerine, lemon, grapefruit, honeydew, cantaloupe, star fruit, mango), apple-cinnamon, raisin cinnamon, rocky road (w/out nuts), cheese cake, cherry, berry (raspberry, blackberry, blueberry), rhubarb, mint chocolate chip, vanilla bean, carrot-cake, and raisin butter. The food bars of the invention can be sold in bulk packages depending on the needs of the customers.

Following are examples that illustrate procedures for practicing the invention. These examples should not be construed as limiting. All percentages are by weight and all solvent mixture proportions are by volume unless otherwise noted.

### EXAMPLE 1

### Ingredient Formulation for Food Bar with Buckwheat and Fruit Filling

The following provides a food bar of the invention that is formulated to provide a low-allergenic product to promote health and improve activity.

The dough and filling for one bar preferably comprises: 1.875 g buckwheat flour, 1.875 g of tapioca flour, 2.465 g quinoa flour, 19.975 g of amaranth, 0.20 g vanilla extract, 0.20 g cinnamon extract, 0.20 g of butter flavoring, 0.71 g millet, 15 g of pear juice and or/fruit components, 29 g water, 0.14 g baking powder, 3.75 g Splenda®/brown sugar mix, 2.465 g quinoa, and 2.25 g date sugar, 1.8 g of gelatin, 15 g of raisins, and 5 grams of other fruit components. The following Table 3 provides nutritional information regarding each of the ingredients recited above as provided in a bar of the invention.

TABLE 3
Nutritional Information for Dough of Example 1

| | Tapioca | Buckwheat | Splenda | Amaranth | Quinoa | Raisin | date sugar |
|---|---|---|---|---|---|---|---|
| | in Bar | in Bar | in bar | in Bar | in Bar | in Bar | in Bar |
| | (1.875 g) | (1.875 g) | (3.75 g) | (19.975 g) | (2.465 g) | (15 g) | (2.25 g) |
| calories | 6.25 | 6.875 | 18.75 | 76.5 | 9.57 | 48.75 | 7.5 |
| total fat | 0 | 0.09375 | 0 | 1.275 | 0.145 | 0 | 0 |
| sat fat | 0 | 0 | 0 | 0.425 | 0 | 0 | 0 |
| trans fat | 0 | 0 | 0 | 0 | 0 | 0 | 0 |
| cholesterol | 0 | 0 | 0 | 0 | 0 | 0 | 0 |
| sodium | 0 | 0 | 0 | 4.25 | 0.2175 | 3.75 | 0 |
| total carb. | 1.625 | 1.25 | 3.75 | 13.175 | 1.6675 | 11.625 | 1.875 |
| dietary fiber | 0 | 0.375 | 0 | 2.975 | 0.1595 | 0.75 | 0 |
| sugars | 0 | 0.0625 | 3.75 | 0.425 | 0.0725 | 10.875 | 1.5 |
| protein | 0 | 0.3125 | 0 | 2.975 | 0.29 | 0.375 | 0 |
| vitamin A (%) | 0 | 0 | 0 | 0 | 0 | 0 | 0 |
| vit C (%) | 0 | 0 | 0 | 1.7 | 0 | 0 | 0 |
| Iron (%) | 0.00125 | 0.375 | 0 | 8.5 | 0.6525 | 2.25 | 0 |
| Calcium (%) | 0 | 0 | 0 | 3.4 | 0.0725 | 0.75 | 0 |
| potassium(mg) | 10.9375 | 0 | 0 | 72.25 | — | 116.25 | 0 |
| riboflavin | — | 0.25 | 0 | 2.55 | — | — | 0 |
| niacin | — | 0.375 | 0 | 1.7 | — | — | — |
| folate | — | — | — | 2.55 | — | — | — |
| thiamin | — | — | — | 0.85 | — | — | — |

| | pear juice | gelatin | totals | | | |
|---|---|---|---|---|---|---|
| | in bar | in bar | in bar | per 2000 | | |
| | (15 g) | (1.8 g) | (100 g) | calorie diet | | % DV |
| calories | 8.0625 | 5 | 187.2575 | 0.09362875 | calories | 9.362875 |
| total fat | 0 | 0 | 1.51375 | 0.023288462 | total fat | 2.328846154 |
| sat fat | 0 | 0 | 0.425 | 0.02125 | sat fat | 2.125 |
| trans fat | 0 | 0 | 0 | 0 | trans fat | 0 |
| cholesterol | 0 | 0 | 0 | 0 | cholesterol | 0 |
| sodium | 0.0625 | 0 | 8.28 | 0.00345 | sodium | 0.345 |
| total carb. | 2.1875 | 0 | 37.155 | 0.0741 | total carb. | 7.431 |
| dietary fiber | 0 | 0 | 4.2595 | 0.17038 | dietary fiber | 17.038 |
| sugars | 1.75 | 0 | 18.435 | 0.03687 | sugars | 3.687 |
| protein | 0 | 2 | 5.9525 | 0.011905 | protein | 1.1905 |
| vitamin A (%) | 0 | 0 | 0 | 0 | vitamin A (%) | 0 |
| vit C (%) | 5.5 | 0 | 7.2 | 14.4 | vit C (%) | 1440 |
| Iron (%) | 0.3125 | 0 | 12.09125 | 24.18125 | Iron (%) | 2418.125 |
| Calcium (%) | 0.125 | 0 | 4.3475 | 8.695 | Calcium (%) | 869.5 |
| potassium(mg) | 6.25 | 0 | 205.6875 | 0.058767857 | potassium(mg) | 5.876785714 |
| riboflavin | — | — | 2.8 | 5.6 | riboflavin | 560 |
| niacin | — | — | 2.075 | 4.15 | niacin | 415 |
| folate | — | — | 2.55 | 5.1 | folate | 510 |
| thiamin | — | — | 0.85 | 1.7 | thiamin | 170 |

The dough preferably comprises: 1.875 g of tapioca flour, 1.875 g of buckwheat, 2.465 g quinoa flour, 0.1 g vanilla extract, 0.1 g of cinnamon extract, 0.71 g millet, 15 g pear juice, 29 grams of water, 2.34 g Splenda®/brown sugar mix, and 1.125 g date sugar.

The filling preferably comprises: 15 g of raisins, 0.2 g vanilla extract, 0.1 g cinnamon extract, 0.05 g nutmeg, 0.05 g cloves, addition of supplements (variable amounts), 1.41 g Splenda®/brown sugar mix, 3.14 g apricot, 1.86 g mandarin, 1.8 g gelatin, 1.125 g date sugar, 19.975 g of whole amaranth.

The dough and filling are prepared in accordance with the processes described herein. For example, after preparation of the dough and filling, the dough is transferred to an extruder. The filling is then distributed in a layer on the extrudate/dough. The dough is then folded over the filling layer and sealed. Preferably, the food bar of the invention comprises about 70-80% filling and about 20-30% dough.

### EXAMPLE 2

### Ingredient Formulation for Food Bar with Fruit Filling

The following provides a food bar of the invention that is formulated to provide a low-allergenic product to promote health and improve activity.

The dough preferably comprises: 2.14 g of tapioca flour, 3.28 g quinoa flour, 0.27 g vanilla extract, 0.22 g cinnamon extract, 0.22 g of butter flavoring, 0.71 g millet, 2.85 g of pear juice, 0.14 g baking powder, 4.28 g Splenda®/brown sugar mix, 1.42 g quinoa and 0.71 g date sugar for kneading.

Alternatively, the dough comprises: The dough preferably comprises: 3.28 g of tapioca flour, 2.14 g quinoa flour, 0.27 g vanilla extract, 0.22 g cinnamon extract, 0.22 g of butter flavoring, 0.71 g millet, 2.85 g of pear juice, 0.14 g baking powder, 4.28 g Splenda®/brown sugar mix, 1.42 g quinoa and 0.71 g date sugar for kneading.

The filling preferably comprises: 11.00 g of mandarins (whole), 0.54 g vanilla extract, 0.45 g cinnamon extract, 0.45 g butter flavoring, 0.05 g nutmeg, 0.05 g cloves, addition of supplements (variable amounts), 4.42 g Splenda®/brown sugar mix, 3.14 g apricot, 1.42 g gelatin, 1.42 g date sugar, 15.00 g of whole amaranth. The dough and filling are prepared in accordance with the processes described herein. For example, after preparation of the dough and filling, the dough is transferred to an extruder. The filling is then distributed in a layer on the extrudate/dough. The dough is then folded over the filling layer and sealed. Preferably, the food bar of the invention comprises about 70-80% filling and about 20-30% dough.

### EXAMPLE 3

### Nutrition Label

Following is an example of a nutrition label that can be used according to the subject invention.

| Nutriton Facts | |
|---|---|
| Serving size 1 Bar | |
| (100 g) | |
| Calories | 201.5 |
| Calories from fat | 15 |

Percentage daily values based on a 2,000 calorie diet

| | % Daily Value |
|---|---|
| Total fat 1.5 g | 3% |
| Sat fat 0.5 g | 3% |
| Trans fat 0 g | 0% |
| Cholesterol 0 g | 0% |
| Sodium 8 mg | 0% |
| Total carb 37 g | 12% |
| Dietary fiber 4 g | 17% |
| Sugars 18 g | |
| Protein 10 g | |
| Vitamin A (%) | 50% |
| Vitamin C (%) | 100% |
| Iron (%) | 12% |
| Calcium (%) | 100% |
| Potassium 205 mg | 100% |
| Riboflavin | 100% |
| Niacin | 100% |
| Folate | 100% |
| Thiamin | 100% |

INGREDIENTS: whole amaranth, flour (quinoa, tapioca, buckwheat, millet, brown rice), raisins, pear juice, date sugar, brown sugar/Splenda® mix, gelatin, water, creatine, baking powder, leucine, arginine, carnitine, L-proprionyl carnitine, natural flavorings, vitamins and minerals.

In a preferred embodiment, the nutrition label is in a clear and easy to read format. This format is standardized in order to easily compare the ingredients of the subject food bar to similar products. The label that is specifically exemplified herein was set up to address the nutrients that are an important focus to today's consumers. The order in which it appears reflects the priority of current dietary recommendations. All nutrients should be declared as a percentage of the Daily Values. These percents are based on a 2000 and 2500 calorie diet. By giving the information in a percent form it reduces the chance of information from being misinterpreted.

Depending upon an individual's dietary needs low values may not be necessarily good and high values may not be necessarily bad. Serving sizes should be stated in terms that are visually familiar to the consumer and reflect the amounts a consumer may eat. The sizes should be listed in both household and metric forms in order to be more universal.

Nutrient claims that are on the label must adhere to a set of standards. The claim of “low-allergenic” is listed if there is less than 0.5 grams of any Big 8 allergen. As previously discussed, each food bar has 0 grams or negligible amounts of any one or combination of Big 8 allergens. Finally, ingredient declaration is required for foods that have more than one ingredient. The ingredient list is in descending order of predominance and is declared by common names (Schmidt, R. Regulation of Food Labeling. In Government Regulations and the Food Industry. University of Florida Coursebook, Gainesville, 2002; p. 166, 198).

All patents, patent applications, provisional applications, and publications referred to or cited herein are incorporated by reference in their entirety to the extent they are not inconsistent with the explicit teachings of this specification.

We claim:

1. A low-allergenic food product that comprises a protein source and substantially excludes compounds derived from dairy products, eggs, shellfish, soy, fish, peanuts, tree-nuts, and wheat, wherein the protein source is derived from compounds other than from dairy products, eggs, shellfish, soy, fish, peanuts, tree-nuts, and wheat.

2. The low-allergenic food product of claim 1, wherein the protein source is any one or more of the ingredients selected from the group consisting of: spelt, quinoa, amaranth, buckwheat, rice, fava flour, and garbanzo flour.

3. The low-allergenic food product of claim 1, further comprising any one or more of the following ingredients: at least one carbohydrate; at least one dietary supplement selected from the group consisting of: creatine, choline, leucine, and alpha lipoic acid, at least one vitamin; and at least one mineral; wherein none of these ingredients are derived from dairy products, eggs, shellfish, soy, fish, peanuts, tree-nuts, and wheat.

4. An article of manufacture comprising at least one low-allergenic energy food product of claim 1 packaged in a latex- and lead-free material.

5. The article of claim 4, wherein the latex- and lead-free material is plastic or aluminum.

6. The article of claim 4, wherein the wrapping is vacuum-sealed and or flushed.

7. A low-allergenic food product that comprises any one or more of the following ingredients: at least one carbohydrate; at least one dietary supplement selected from the group consisting of: creatine, choline, leucine, and alpha lipoic acid, at least one vitamin; and at least one mineral; wherein none of these ingredients in the food product are derived from dairy products, eggs, shellfish, soy, fish, peanuts, tree-nuts, and wheat.

8. The low-allergenic food product of claim 7, wherein the carbohydrate is selected from the group consisting of: pea, buckwheat, tapioca, rice, quinoa, millet, amaranth, sorghum flour, fava flour, and garbanzo flour.

8. The low-allergenic food product of claim 7, wherein the vitamin is selected from the group consisting of: Vitamin A; B₁ Vitamin; B₂ Vitamin; B₃ Vitamin; B₅ Vitamin; B₆ Vitamin; Biotin; Folic acid; B₁₂ Vitamin; Vitamin C, Vitamin E; Vitamin K; para-aminobenzoic acid; niacin; and inositol.

10. The low-allergenic food product of claim 7, wherein the mineral is selected from the group consisting of: magnesium, iron, zinc, copper, manganese, sodium, potassium, calcium, selenium, chromium, molybdenum, chloride, fluorine, phosphorous, sulfur, and iodine.

11. A low-allergenic energy food product comprising: at least one carbohydrate selected from the group consisting of: buckwheat, tapioca, rice, quinoa, millet, amaranth, sorghum flour, and pea; at least one form of protein; at least one dietary supplement selected from the group consisting of: creatine, choline, leucine, and alpha lipoic acid; a wetting agent, at least one sweetener, and a flavoring agent; wherein the low-allergenic energy food product substantially excludes compounds derived from dairy products, eggs, shellfish, soy, fish, peanuts, tree-nuts, and wheat.

12. The low-allergenic energy food product of claim 11, wherein less than 10 ppm of either dairy product, eggs, shellfish, soy, fish, peanuts, tree-nuts, and wheat are present in the low-allergenic energy food product.

13. The low-allergenic energy food product of claim 11, wherein the at least one carbohydrate is selected from the group consisting of the following in the specified ranges: buckwheat at about 0-70% by weight; tapioca at about 0.5-70% by weight; quinoa at about 0.5-70% by weight; rice at about 0.5-70% by weight; millet at about 0.5-70% by weight; and amaranth at about 0.5-70% by weight.

14. The low-allergenic energy food product of claim 11, wherein the at least one dietary supplement is selected from the group consisting of the following in the specified ranges: creatine at about 0.001-5% by weight; choline at about 0.001-1% by weight; leucine at about 0.001-3% by weight; and alpha lipoic acid at about 0.001-1% by weight.

15. The low-allergenic energy food product of claim 11, wherein the wetting agent is selected from the group consisting of: water, fruit juice, rice milk, and hemp milk, wherein the wetting agent is present in the food product at a range from about 1-50% by weight.

16. The low-allergenic energy food product of claim 11, wherein the at least one sweetener is selected from the group consisting of: refined sugars, unrefined sugars, sugar alcohols, and high intensity sweeteners, wherein the sweetener is present in the food product at a range from about 1-80% by weight.

17. The low-allergenic energy food product of claim 11, wherein the flavoring agent is selected from the group consisting of: mint, peppermint, spearmint, cinnamon, nutmeg, cloves, ginger, wintergreen, vanilla, fruit, fruit extracts and essences, peppers, chili pepper, chocolate, carob, caramel, sarsaparilla, sassafras, salt, wild cherry, ginger, nutmeg, malt, grain flavors, paprika, garlic, peanut butter and jelly, cookie dough, black cherry, cranberry, strawberry, apricot, chocolate cinnamon, prune, cinnamon raisin, apple cinnamon, carrot cake, and pumpkin spice.

18. The low-allergenic energy food product of claim 11, further comprising any one or combination of the following: a gelling agent that is present in the food product at a range from about 0.001-5% by weight; a masking agent that is present in the food product at a range from about 0.001-10% by weight; an emulsifying agent that is present in the food product at a range from about 0.001-15% by weight; or a leavening agent that is present in the food product at a range from about 0.001-5% by weight.

19. A method of preparing a low-allergenic energy food product comprising:
a) processing at least one carbohydrate selected from the group consisting of: buckwheat, tapioca, rice, quinoa, millet, amaranth, sorghum flour, and pea; at least one form of protein; at least one dietary supplement selected from the group consisting of: creatine, choline, leucine, and alpha lipoic acid; a wetting agent, at least one sweetener, and a flavoring agent together;
b) heating and stirring the processed ingredients of step a) to form a malleable dough;
c) transferring the dough to an extruder to provide an extrudate; and
d) cutting the extrudate into a desirable shape.

20. A method of improving an individual's overall health comprising promoting a low-allergenic energy food product for ingestion as pait of a specialized diet and providing the low-allergenic energy food product; wherein the low-allergenic energy food product comprises at least one carbohydrate selected from the group consisting of: buckwheat, tapioca, rice, quinoa, millet, amaranth, sorghum flour, and pea; at least one form of protein; at least one dietary supplement selected from the group consisting of: creatine, choline, leucine, and alpha lipoic acid; a wetting agent, at least one sweetener, and a flavoring agent; wherein the low-allergenic energy food product substantially excludes compounds derived from dairy milk, eggs, shellfish, soy, fish, peanuts, tree-nuts, and wheat.

21. The method of claim 20, wherein the specialized diet is a high-protein, low-carbohydrate diet.

22. The method of claim 20, wherein the specialized diet is a low-allergenic diet.

23. The method of claim 20, wherein the improvement to an individual's overall health comprises: lowering cholesterol levels, increasing overall energy levels, enhancing exercise or daily performance, enhancing neuronal function, and reducing fatigue in healthy individual and in individuals suffering from degenerative or autoimmune disease states.

24. The method of claim 20, wherein the low-allergenic energy food product is provided by a facility that promotes or provides exercise regimens, and wherein the low-allergenic energy food product is sold to individuals who attend the facility.

25. The method of claim 20, wherein the low-allergenic energy food product is provided by retail store purchase, catalog order, and/or internet.
